(19) United States
(12) Patent Application Publication
(10) Pub. No.: US 2020/0036057 A1
(43) Pub. Date: Jan. 30, 2020

(54) SYSTEM FOR IMPLEMENTING REAL-TIME MONITORING AND DYNAMIC REPAIR OF REMOTELY CONTROLLED BATTERY PACK BASED ON REMOTE SENSING TECHNOLOGY

(71) Applicant: Michael Wang, Beijing (CN)

(72) Inventor: Michael Wang, Beijing (CN)

(21) Appl. No.: 16/043,529

(22) Filed: Jul. 24, 2018

(51) Int. Cl. H01M 10/48; B60L 11/18

(52) U.S. Cl. CPC H01M 10/482; H01M 2220/20; B60L 11/1851

(57) ABSTRACT

A system is provided for implementing real-time monitoring and dynamic repair of a remotely controlled battery pack based on a remote sensing technology in the field of electrochemical batteries. Three system platforms, namely, a real-time remote-sensing information acquisition platform, a remote-sensing information processing platform, and a technical service platform are established for a remotely controlled battery pack. The system platforms are connected through a wireless network for information transmission. In the present invention, a remote sensing technology is used to implement real-time monitoring and dynamic repair for variations in the remotely controlled battery pack. Cell parameters, voltage parameters, capacity parameters, temperature parameters, internal resistance parameters, and charging and discharging parameters and the like are controlled in a safe state in real time.

### TECHNICAL FIELD

The present invention relates to the field of monitoring electrochemical batteries, and, in particular, relates to a system for implementing real-time monitoring and dynamic repair of a remotely controlled battery pack based on a remote sensing technology.

### BACKGROUND

In present times, there are practical concerns about energy conservation, emission reduction, environmental protection, greenhouse gases, global warming, decreasing oil reserves, and high oil prices. For example, the industrialization of electric cars becomes especially urgent and necessary. However, the performance of an electric vehicle is restricted by the performance of a battery pack. The performance of a battery pack is closely related to variations of physical and chemical performance among cells and modules when the battery pack is working. Currently, electric car manufacturers only perform regular maintenance to resolve potential safety hazards caused by variations in the use of battery packs. The method cannot solve the bottleneck of safety requirements in the industrialization of electric vehicles.

Batteries with high specific energy such as high-power lithium batteries are increasingly used in electric cars. However, such battery packs have very high requirements on variations among cells and modules. A main variation phenomenon in a battery pack is that cells have inconsistent internal resistances, voltages, capacities, and temperatures. If internal resistances, especially, polarization internal resistances, of cells are inconsistent, voltages of individual cells change relatively violently during charging and discharging. As a result, the voltage of an entire battery pack changes violently, and the peak regulation capability of the battery pack is affected. Cells have different capacities. During use, some cells are fully charged or drained sooner than other cells, and consequently, are easily overcharged or over-discharged. As a result, the service life of the battery pack is shortened, and a risk of battery combustion or explosion may be increased. Cells release and absorb heat during working, and the temperatures of the cells keep changing. When temperature changes are inconsistent, some cells may exceed an applicable temperature range, resulting in reduced performance and potential safety hazards.

The foregoing four inconsistency phenomena are not isolated, but instead are mutually influential and coupled. Therefore, variation control and repair during use of high-power battery modules for electric cars become problems that need to be resolved. By performing remote-sensing monitoring and repair on a remotely controlled battery pack, the variation safety of a battery pack is monitored throughout the life cycle of the battery pack, that is, from initial use to product recycling, so that the service life of the battery pack is greatly extended, and the operation costs are reduced.

Thus, it would be desirable to improve batteries and monitoring devices to address these and other drawbacks in the known art.

### SUMMARY

To overcome the foregoing deficiencies, the objective of the present invention is to provide a system for implementing real-time monitoring and dynamic repair of a remotely controlled battery pack based on a remote sensing technology.

In one embodiment of the system, three system platforms, namely, a remote-sensing information acquisition platform, a remote-sensing information processing platform, and a technical service platform are connected through a wireless network for information transmission.

More specifically, a remote sensing technology is applied to a high-capacity, high-ratio, high-power battery pack to resolve potential safety hazards caused by variations of physical and chemical properties among cells and modules during application. Three system platforms, namely, a remote-sensing information acquisition platform, a remote-sensing information processing platform, and a technical service platform, are established to implement real-time monitoring and dynamic repair of a remotely controlled battery pack, thereby greatly improving the safety and service life of high-capacity power battery packs during application.

In one aspect, the wireless network is the Internet, a mobile-network public information service platform, or satellite-based positioning.

In another aspect, the remote-sensing information acquisition platform is a high-power digital battery pack formed by connecting a digital battery pack management unit and each sensor on 1 to n digital cells.

In a further aspect, one current sensor, one voltage sensor, and one temperature sensor are mounted between positive and negative electrode tabs of each digital cell forming the high-power digital battery pack.

In one aspect, the remote-sensing information processing platform is a monitoring service center formed of a database, a server, a user, a firewall, and a router connected together.

In yet another aspect, the technical service platform includes a 4S service center and a logistics service center.

In some embodiments according to the invention, the user includes an enterprise, an individual, and a PDA.

It will be understood that the quantity n of cells depends on the capacity of the high-power digital battery pack.

In another aspect, the database includes enterprise data, map information and GPRS information.

Furthermore, the server uses WEB or GIS resources.

The advantages and technical effects achieved by the present invention are as follows. The remote-control system may be applied to short range control of battery pack information in a local area space in a 1-km range, or may use a GIS, GPS or GPRS wireless communication network to collect remote messages and send an instruction (an alarm or a dedicated control signal) to a master control unit from which information is collected. The present invention can overcome potential hazards caused by variations in a working state of a high-capacity battery pack. A potential safety hazard that it is difficult to control variations of physical and chemical properties of a high-capacity battery pack during use is resolved, thereby greatly improving the application reliability of a high capacity, high-power battery pack, and greatly improving the safety and the service life of a battery pack. The implementation of the present invention will promote and accelerate the industrialization of pure electric vehicles.

### BRIEF DESCRIPTION OF THE DRAWING

Various additional features and advantages of the invention will become more apparent to those of ordinary skill in the art upon review of the following detailed description of one or more illustrative embodiments taken in conjunction with the accompanying drawing. The accompanying drawing, which is incorporated in and constitutes a part of this specification, illustrates one or more embodiments of the invention and, together with the general description given above and the detailed description given below, explains the one or more embodiments of the invention.

FIG. 1 is a schematic diagram of a system for implementing real-time monitoring and dynamic repair of a remotely controlled battery pack based on a remote sensing technology, in accordance with an embodiment of the invention.

### DETAILED DESCRIPTION

The present invention provides a system for implementing real-time monitoring and dynamic repair of a remotely controlled battery pack based on a remote sensing technology. Embodiments of the invention are illustrated below with reference to the accompanying drawing. The preferred embodiments described here are used only to describe and explain the present disclosure, but not to limit the present disclosure.

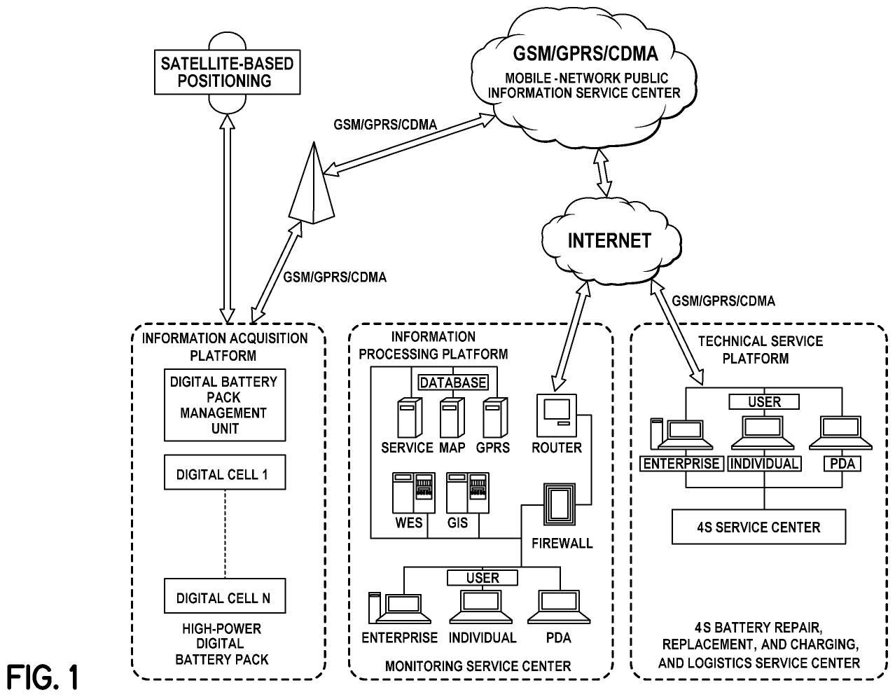

In a compositional schematic diagram shown in FIG. 1 of a system for implementing real-time monitoring and dynamic repair of a remotely controlled battery pack based on a remote sensing technology, three system platforms, namely, a remote-sensing information acquisition platform, a remote-sensing information processing platform, and a technical service platform are connected through a wireless network for information transmission. The wireless network is the Internet, a mobile-network public information service platform, or satellite-based positioning.

The remote-sensing information acquisition platform includes a digital battery pack management unit and 1 to n digital cells forming a high-power digital battery pack. During the production of a high-capacity battery pack, one current sensor, one voltage sensor, and one temperature sensor are mounted in suitable positions between positive and negative electrode tabs of each digital cell of the battery pack. These sensors are connected to the digital battery pack management unit to form an information collection apparatus. The digital battery pack management unit performs digital-to-analog conversion processing on collected information and transmits obtained remote sensing data to a data processing platform of a monitoring service center through wireless transmission. A remote sensor uses GPS data reception, integrates a digital switch input/output interface, and uses an appropriate control technology. A GPRS data channel is used to implement real-time transmission of battery pack positions and variation status information.

Remote sensing data transmission is connected to a host by using RS-232 or 485. A specific communication protocol may be customized by a user. The remote sensing data includes variation information of parameters such as internal resistances of cells, voltages of cells being in a range from 2.0 V to 4.5 V, a quantity n of digital cells forming the high-power digital battery pack that is determined by using a specific capacity of a high-capacity battery pack from 30 Ah to 1000 Ah, working temperatures of cells being between −50° C. and 70° C., and charging and discharging parameters. The data further includes real-time positioning (video and vector information), movement rate information, and remote-control information (power-off, short-circuit, alarms, and the like) involved throughout the application of the remotely controlled battery pack.

A GPS battery pack monitoring center system uses an advanced open system having a distributed hierarchical system architecture. The system capacity is large, the integration of computer network technologies and data processing technologies is supported, desirable expansibility and extensibility, and software development is more flexible.

The remote-sensing information processing platform is a monitoring service center formed by a database, a server, a user, a firewall, and a router connected together. The database includes enterprise data, map information and GPRS information. The server uses WEB or GIS resources. The monitoring service center performs sequential coding and encryption on information obtained by a collection unit, records the information in a corresponding storage medium, and at the same time transfers the information to an information processing terminal by using GPRS, CDMA or GPS for recording and displaying. The collected information is processed by using system software to obtain current statuses and historical change records of a current battery pack and cells in the battery pack, to determine a working condition of the battery pack and working conditions of the cell in the battery pack, so as to obtain an encrypted sequence signal that includes geographical information and reflects working conditions of the battery pack and the cells in the battery pack and instruct a user, by using a GIS, GPS, or GPRS positioning apparatus, to handle a problematic battery pack. The user includes an enterprise, an individual, and a PDA.

The technical service platform includes a 4S service center and a logistics service center. The user receives data showing that the variation of a cell is lower than the entire battery pack by 3% to 35% and an automatic alarm message of the system and goes to a designated 4S service center to perform quantitative charging of a remotely controlled battery or replace a problematic cell. A charging station performs quantitative charging of the remotely controlled battery under the guidance of processed remote sensing data.

This remote-control system may be applied to short range control of battery pack information in a local area space in a 1-km range, or may use a GIS, GPS or GPRS wireless communication network to collect remote messages and send an instruction (an alarm or a dedicated control signal) to a master control unit from which information is collected. This remote-control system may overcome potential hazards caused by variations in a working state.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A system for implementing real-time monitoring and dynamic repair of a remotely controlled battery pack based on a remote sensing technology, comprising three system platforms, namely:
a remote-sensing information acquisition platform,
a remote-sensing information processing platform, and
a technical service platform
wherein the three system platforms are connected through a wireless network for information transmission,
the remote-sensing information acquisition platform is a high-power digital battery pack formed by connecting a digital battery pack management unit and each sensor on 1 to n digital cells;
the remote-sensing information processing platform is a monitoring service center formed of a database, a server, a user, a firewall, and a router connected together; and
the technical service platform comprises a 4S service center and a logistics service center.

2. The system of claim 1, wherein the wireless network is the Internet, a mobile-network public information service platform, or satellite-based positioning.

3. The system of claim 1, wherein one current sensor, one voltage sensor, and one temperature sensor are mounted between positive and negative electrode tabs of each digital cell forming the high-power digital battery pack.

4. The system of claim 1, wherein the user comprises an enterprise, an individual, and a PDA.

5. The system of claim 1, wherein a quantity n of the digital cells depends on a capacity of the high-power digital battery pack.

6. The system of claim 1, wherein the database comprises enterprise data, map information and GPRS information.

7. The system of claim 1, wherein the server uses WEB or GIS resources.
